(19) United States
(12) Patent Application Publication
(10) Pub. No.: US 2008/0180412 A1
(43) Pub. Date: Jul. 31, 2008

(54) Dual mode digitizer

(75) Inventor: Michael H. Tsang, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/700,332

(22) Filed: Jan. 31, 2007

(51) Int. Cl. G06F 3/033

(52) U.S. Cl. 345/179

(57) ABSTRACT

A dual-mode device driver functions either as a mouse or as a digitizer. A switch associated with the input device alternates the mode of operation between the two. The switch may be implemented in hardware or with software.

### BACKGROUND

Most modern computing systems include a graphical user interface that provides the user with more intuitive control. A typical graphical user interface has for some time been controlled with a combination of keyboard and pointing device manipulations. The conventional pointing device is a computer mouse. However, special purpose computer input devices called “digitizers” are also in relatively widespread use. Digitizers differ somewhat from computer mice in that digitizers report the absolute locations of the stylus at periodic intervals whereas mice report the relative movement of the device since the last sample point. Typically, mice are used as a navigating input device where the current location is more important than the path it took to get to the current location. For this reason, it is not uncommon for the Operating System to drop data points of the traveled path in favor of keeping the current location accurate. This behavior makes mice a poor inking device where the accuracy of the traveled path is very important. Any missing data points in the traveled path will result in distorted ink and will affect functionalities such as the accuracy of hand-writing recognition.

For this and other reasons, software drivers written for digitizers are significantly more complex than drivers for mice. However, digitizer manufacturers typically avoid the need for a special digitizer driver by announcing the digitizer to the system as a mouse rather than as a digitizer. In this way, the digitizer manufacturers can leverage the mouse driver that is typically included with the operating system. Although this enables the digitizer to connect and navigate the graphical user interface, the functionality provided by the mouse driver is, as mentioned, less than complete, thus losing some of the key functionality of the digitizer. In many cases, the loss is acceptable because the digitizer is merely being used as a mouse for navigation, which is frequently the case with older or less expensive digitizers. However, in certain circumstances, such as “inking,” the lost functionality is unacceptable.

An adequate solution to this problem has eluded those skilled in the art, until now.

### SUMMARY

The invention is directed generally at providing a standard input device driver that functions in two modes of operation, either as a mouse or as a digitizer. A switch associated with the input device alternates the mode of operation between the two. The switch may be implemented in hardware or with software.

### BRIEF DESCRIPTION OF THE DRAWINGS

Many of the attendant advantages of the invention will become more readily appreciated as the same becomes better understood with reference to the following detailed description, when taken in conjunction with the accompanying drawings, briefly described here.

FIG. 1 is a graphical illustration of a computing system in which embodiments of the invention may be implemented.

FIG. 2 is a functional block diagram generally illustrating functional components of an execution environment for providing dual-mode operation for a digitizer, in accordance with one embodiment.

FIG. 3 is a graphical illustration of a device tree in which each device driver on a host computing system is represented.

FIG. 4 is a functional block diagram of an exemplary computing device that may be used to implement one or more embodiments of the invention.

FIG. 5 is an operational flow diagram generally illustrating a process for supporting dual-mode operation of a digitizer.

FIG. 6 is an operational flow diagram generally illustrating a process for initializing a dual-mode driver, in accordance with one embodiment.

Embodiments of the invention will now be described in detail with reference to these Figures in which like numerals refer to like elements throughout.

### DETAILED DESCRIPTION OF THE DRAWINGS

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Generally stated, the described embodiments include mechanisms and techniques for supporting a digitizer with a dual-mode device driver. The digitizer can switch between mouse mode and digitizer mode.

Illustrative Systems

The principles and concepts will first be described with reference to a sample system that implements certain embodiments of the invention. This sample system may be implemented using conventional or special purpose computing equipment programmed in accordance with the teachings of these embodiments.

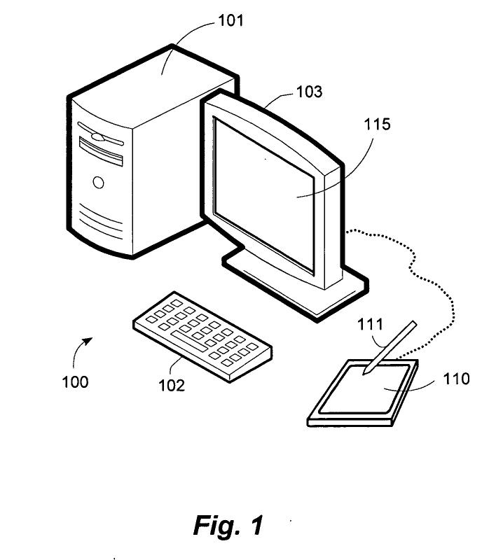

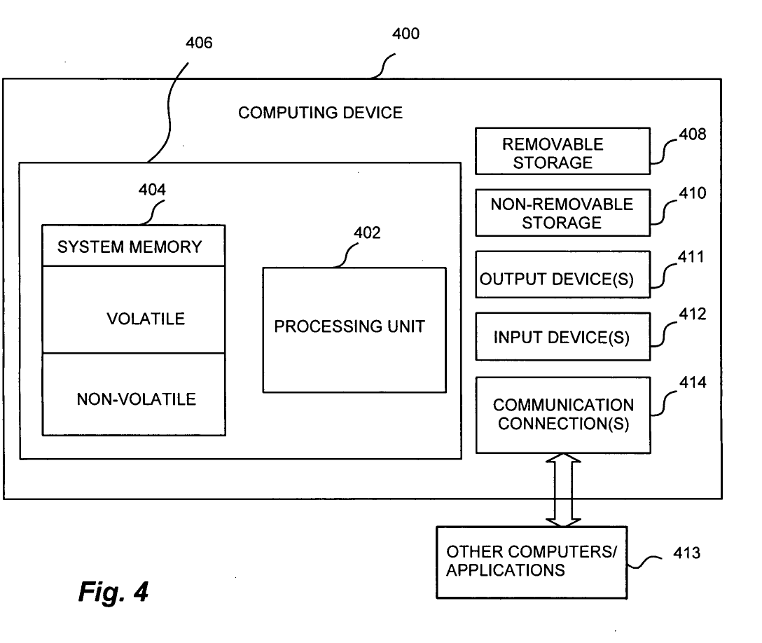

FIG. 1 is a graphical illustration of a computing system 100 in which embodiments of the invention may be implemented. The computing system 100 may be based on any conventional computing device, such as the computing device illustrated in FIG. 4 and described below, configured in accordance with the teachings of this disclosure.

The computing system 100 includes a processing unit 101, a keyboard 102, and a display 103. In some implementations, such as Tablet PCs, the keyboard 102 may be virtualized in software or even omitted entirely. The computing system 100 of this example also includes a digitizer 110 configured in accordance with one embodiment. The digitizer 110 may include a touch-sensitive surface that detects pressure applied by a stylus 111 or finger, and converts that information to electrical signals which are transmitted to the processing unit 101 for processing. Commonly, the signals are interpreted as movements of a graphical pointer. Alternatively, the signals may be interpreted as selections of buttons (or the like) that are shown on the display 103.

Alternatives to passive digitizers (e.g., touch-sensitive) include active digitizers which operate with a stylus 111 that radiates an electrical or magnetic signal, which is detected by the digitizer 110. Embodiments may be implemented using either touch-sensitive digitizers, active digitizers, or any other type of digitizer based on any operative technology.

In some embodiments, the display 103 may have an integrated touch-sensitive digitizer 115. In these embodiments, the digitizer 115 may be implemented as a touch-sensitive transparent screen laid over the screen of the display 103. In this way, the user can simply touch elements of the display in a more intuitive manner. The integrated digitizer 115 may be in addition to, or in lieu of the free-standing digitizer 110.

In operation, the digitizer 110/115 is coupled to the processing unit 101. The digitizer 110/115 may include firmware that identifies itself to the processing unit 101, but it may not. Specially configured driver software executing on the processing unit 101 detects the presence of the digitizer 110/115 when connected and establishes communications between other software executing on the processing unit 101 and the digitizer 110/115. In this embodiment, the driver software reports the digitizer 110/115 as two different devices: (1) a mouse and (2) a digitizer. The driver software detects which of at least two states the digitizer is operating in, and communicates with the other software using either the mouse device or the digitizer device based on the operating state.

The advantages of this system are many. For instance, this system enables a digitizer manufacturer to deploy a single version of a driver that will communicate properly with both digitizer-aware and non digitizer-aware computing systems. A non digitizer-aware computing system may be using an operating system that does not understand the commands and instructions that a typical digitizer driver sends. In those cases, the digitizer can be switched to operate in mouse-mode, thus providing an adequate level of functionality. When connected to a digitizer-aware computing system, the digitizer can be switched to operate in digitizer-mode, thus providing the enhanced functionality that may be necessary for certain functions, such as handwriting recognition.

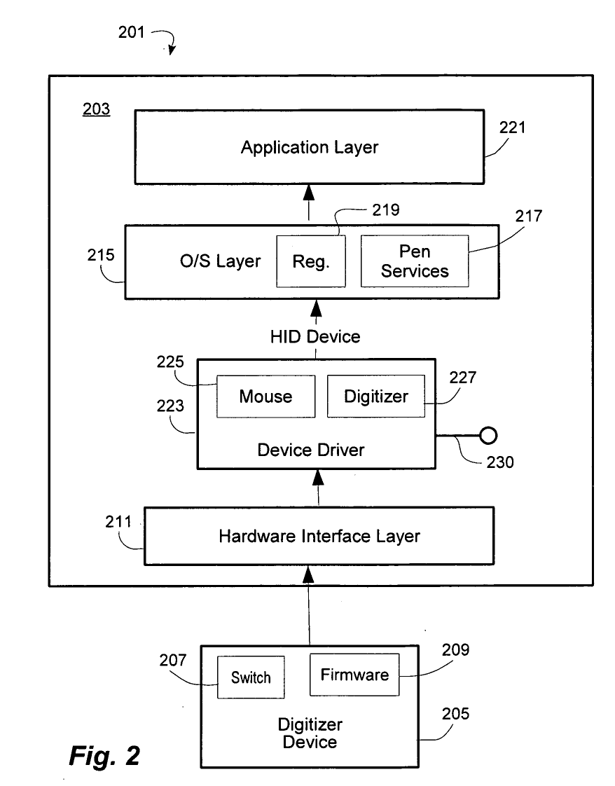

FIG. 2 is a functional block diagram generally illustrating functional components of an execution environment 201 for providing dual-mode operation for a digitizer 205, in accordance with one embodiment of the invention. Generally stated, the execution environment 201 is a software environment executing on a host computer, such as the computing system 100 (FIG. 1). The components illustrated in FIG. 2 are illustrative only and are provided for the purpose of describing functionality that may be implemented in various embodiments. Many other embodiments may be implemented with components that differ in detail from those described here.

The execution environment 201 includes a computing system 203 and a digitizer 205. In this embodiment, the digitizer 205 is a peripheral for sensing a position of a pointing mechanism on the surface of the peripheral and for reporting the position of the pointing mechanism to a computing device. The pointing mechanism may be an active stylus or puck (e.g., stylus 111 in FIG. 1), or it may be a passive instrument, such as a pen or finger. For simplicity of discussion only, any and all forms of pointing mechanism that may be used with a digitizer shall be referred to generically herein as a “stylus.” Digitizers are also sometimes referred to as digitizing tablets, graphics tablets, touch screens, touch pads, and the like.

The digitizer 205 may include a hardware switch 207 for switching the driver 223 between mouse mode and digitizer mode. The switch 207 could be any component operative for causing an electrical signal to alternate between at least two states. In some implementations, the switch 207 could be eliminated and replaced by a software implementation.

The digitizer 205 may include firmware 209 that includes computer-executable code for controlling at least some basic functionality of the digitizer 205, or for reporting some general (and/or specific) descriptive information about the digitizer 205. Various implementations have firmware of varying complexity, and for some implementations the firmware 209 can be very complex, as described more fully below.

The computing system 203 includes various software modules for implementing various functions. In this particular example, the computing system 203 includes a hardware interface layer 21 1 that interacts directly with hardware components, such as the digitizer 205, and accepts and handles interrupts and other low-level hardware functionality.

An operating system layer (O/S layer 215) includes functionality for most basic functions, such as file system management, graphical display rendering, and the like. In some cases, the O/S layer 215 also includes special purpose functionality, such as handwriting recognition software or the like. Although the examples are many, any special purpose software that relies on the enhanced accuracy and/or functionality of digitizer messages is generally referred to here as “pen services” 217. The pen services 217 in this example is included in the O/S layer 215. However, in other implementations, the pen services 217 may be included elsewhere, such as in an applications layer 221.

In one specific example, the pen services 217 relies on the added information provided by conventional digitizers to perform certain tasks, such as handwriting recognition. For instance, to accurately convert handwriting to text, as many points as possible along the path traveled by the stylus should be known. Otherwise, accuracy in the strokes and swirls is lost, making recognition impossible. With conventional mouse drivers, the path traveled by the mouse is typically discarded or not tracked with sufficient detail to perform handwriting recognition. For this and other reasons, handwriting recognition is practically impossible with mouse drivers.

The O/S layer 215 may also include configuration components, such as a system registry 219. The registry 219 is used by software components on the computing system 203 to store configuration information or to make information available to other executing software components. The registry 219 is but one example of a store for persistent configuration information, and many others are possible.

The applications layer 221 includes one or more software applications that may be used on the computing system 203. Any number of applications may be installed on the computing system 203, including productivity software, e-mail software, computer-aided design (CAD) software, and the like. Some applications rely on pen services 217 for proper functioning, such as CAD software.

In this embodiment, the driver 223 supports the digitizer 205 operating as a native digitizer reporting all the digitizer attributes. The driver 223 includes sufficient functionality to receive communication messages from the digitizer 205, delivered via the hardware interface layer 211. In this implementation, the driver 223 is configured with code to report native digitizer activities as received from a typical digitizer. In addition, the driver 223 includes code for translating the information received from the digitizer operating as a digitizer into mouse activities that would ordinarily be provided by a mouse driver.

More specifically, digitizer hardware reports positioning in an absolute basis based on the position of the stylus on the digitizer tablet in its own coordinate system (e.g., “320 pixels right from the origin and 915 pixels down from the origin”) for every position “touched” by the stylus. It also reports the state of the stylus such as touchdown, and in some other digitizer technologies states such as hover, side switch pressed, inverted, eraser pressed or pen-down pressure etc. In contrast, mouse reports very simple events such as relative movements (e.g., “up 40 pixels and left 90 pixels”) and the state of the mouse buttons and wheel. Accordingly, the driver 223 includes translation code to convert the absolute positioning information provided by the digitizer 205 into the absolute mouse coordinate system that the O/S layer 215 would expect from a mouse driver.

For example, the digitizer hardware may report x=1000, y=2000, and it also may report MaxX=4000 and MaxY=4000 so that the O/S layer 215 knows the cursor is about one quarter to the right and half way down the operative area. For a mouse reporting absolute position, it is always assumed that MaxX=32767 and MaxY=32767. For that reason, the driver must proportionally adjust the X and Y values for the mouse event.

The driver 223 in this embodiment is configured in accordance with a Human Input Device (HID) standard developed for input peripherals. The HID standard is a framework for communicating information from an input device to an operating system in a common manner to simplify the construction of messages and drivers. HID devices generally communicate information using “reports,” which represent a packet of information based on activity of the physical device (e.g., digitizer hardware).

Briefly described, the HID standard allows a driver, such as digitizer driver 223, to announce itself as HID compliant to the O/S layer 215. In addition, the HID standard recognizes “HID collections,” which are groupings of HID compliant “controls.” Each HID control is a data source or data sink associated with a HlDClass device. An example of a data source, or input control, is a button. An example of a data sink, or output control, is an LED. Control data is obtained and sent to a device using HID reports.

Controls that return discrete, binary values are referred to as buttons, while controls that return a continuous range of values are referred to as either value usages or, more simply, as values. A letter key on a keyboard and a CAPS LOCK light are examples of buttons. The X axis on a mouse and the intensity of vibration on a force feedback joystick are examples of values. More information about the HID standard, HID collections, the HlDClass device, HID controls, and HID reports may be found by referring to the Windows Driver Kit. Human Input Devices, published by MICROSOFT PRESS and publicly available on the Internet at: “http://msdn.microsoft.com/library”.

In this implementation, the driver 223 includes two report descriptors so that when the driver 223 is initialized, it will report itself as a HID collection having two “children” (e.g., HID controls). One report descriptor is included to create a HID-compliant mouse device 225, and another report descriptor is included to create a HID-compliant digitizer device 227.

In one alternative implementation, the driver 223 also exposes a public interface 230 that enables other software, such as the O/S layer 215 or the applications layer 221, to alter the operating mode of the driver 223. For example, certain implementations may allow the driver 223 to be switched between mouse mode and digitizer mode programmatically. In those implementations, the other software would access the driver 223 via the interface 230 to switch the operating mode. A software switching utility (not shown) could be implemented in the O/S layer 215 or the applications layer 221 in lieu of or in addition to the hardware switch 207. In one specific example, the interface 230 may be implemented as a Component Object Model (COM) interface.

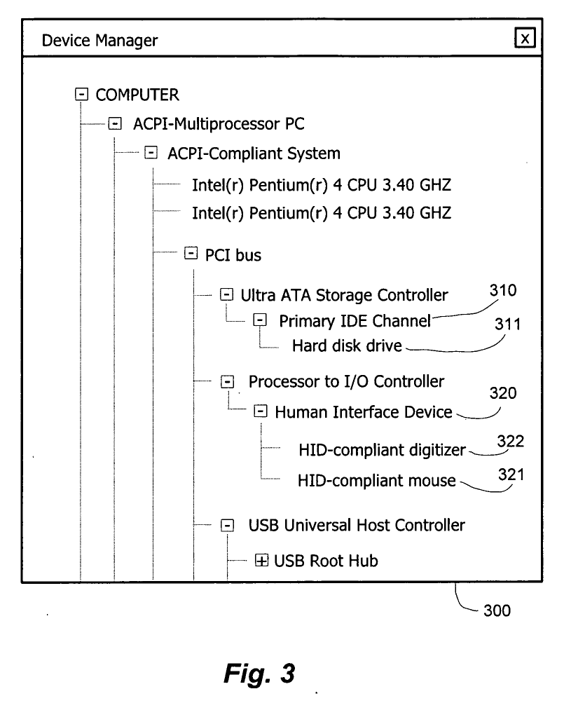

In operation, during initialization, the driver 223 creates a HID device with two children, one for the mouse device 225 and one for the digitizer device 227. In this manner, the O/S layer 215 is presented with two distinct logical devices that may each send input messages. A graphical representation of the logical devices is presented in FIG. 3 and described below.

Also during initialization, the driver 223 determines which of the two modes to operate in. In one implementation, the driver 223 detects which state the hardware switch 207 is in. In another implementation, the driver 223 reads a registry key from the registry 219 that identifies the proper operating mode.

At that point, the driver 223 is operative to receive messages (e.g., movement, clicks, drags, etc.) from the digitizer 205. The driver 223 either transmits the messages to the O/S layer 215 using the mouse device 225 or the digitizer device 227, depending on the current operating mode. Also, as mentioned, if the device driver 223 is operating in mouse mode, the driver 223 may translate the messages from the digitizer 205 into the coordinate system and status that are compatible with conventional mouse drivers. The active logical device (i.e., the device that corresponds to the current operating mode) issues messages to the O/S layer 215. In contrast, the quiet logical device (i.e., the device that does not correspond to the current operating mode) simply idles and awaits instruction.

FIG. 3 is a graphical illustration of a device tree in which each device driver on a host computing system is represented. The device tree 300 enables the user to visually inspect each driver loaded on the host computing system. Many different drivers are represented corresponding to many different devices. For example, an IDE channel node 310 is shown under which a driver for a hard disk drive 311 is represented. User configurable properties for the hard disk drive driver 311 may be viewed and set with this interface.

Referring now to both FIGS. 2 and 3, a HID device 320 is included that corresponds to the digitizer driver 223. As mentioned above, the driver 223 creates a HID device with two children, each of which is reported to the host computing system as a separate device. Accordingly, the HID device 320 includes two children, which each represent one of the two logical devices. A mouse device 321 represents the mouse device 225 in the HID collection created by the driver 223, and a digitizer device 322 represents the digitizer device 227 in the HID collection created by the driver 223.

As described, both logical devices exist in the device tree 300 after initialization. However, only the logical device corresponding to the current operating mode reports digitizer activity to the host computing system. In this way, the digitizer 205 may be represented to the host computer with a single physical driver (driver 223), yet still maintain the advantages of interacting as either a mouse device or a digitizer device, depending on the capabilities of the host computing system. This system simplifies the administrative burden on digitizer manufacturers in that they can implement their hardware with fewer drivers to maintain while still supporting a broader array of operating environments.

FIG. 4 is a functional block diagram of an exemplary computing device 400 that may be used to implement one or more embodiments of the invention. The computing device 400, in one basic configuration, includes at least a processor 402 and memory 404. Depending on the exact configuration and type of computing device, memory 404 may be volatile (such as RAM), non-volatile (such as ROM, flash memory, etc.) or some combination of the two. This basic configuration is illustrated in FIG. 4 by dashed line 406.

Additionally, device 400 may also have other features and functionality. For example, device 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer readable instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400.

Computing device 400 includes one or more communication connections 414 that allow computing device 400 to communicate with one or more computers and/or applications 413. Device 400 may also have input device(s) 412 such as a keyboard, mouse, digitizer or other touch-input device, voice input device, etc. Output device(s) 411 such as a monitor, speakers, printer, PDA, mobile phone, and other types of digital display devices may also be included. These devices are well known in the art and need not be discussed at length here.

Illustrative Processes

The principles and concepts will now be described with reference to sample processes that may be implemented by a computing device, such as the computing device illustrated in FIG. 4, in certain embodiments. The processes may be implemented using computer-executable instructions in software or firmware, but may also be implemented in other ways, such as with programmable logic, electronic circuitry, or the like. In some alternative embodiments, certain of the operations may even be performed with limited human intervention. Moreover, the process is not to be interpreted as exclusive of other embodiments, but rather is provided as illustrative only.

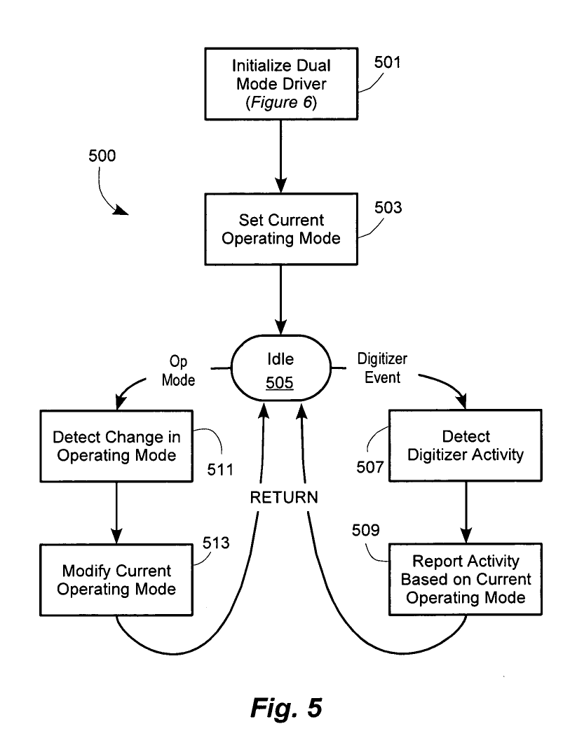

FIG. 5 is an operational flow diagram generally illustrating a process 500 for supporting dual-mode operation of a digitizer. The operations are performed on a host computing system having an attached digitizer.

At block 501, a dual-mode driver is initialized. In this embodiment, the dual-mode driver supports two modes of operation wherein one operating mode is operative to receive a significantly greater degree of input device information pertaining to position accuracy than the other operating mode. The greater degree of input device information may be realized as any one or more forms of position information, such as X/Y coordinates, resolution, pen pressure, pen angle, rotation, and the like. The former operating mode is referred to herein as “digitizer mode,” and the latter operating mode is referred to herein as “mouse mode.”

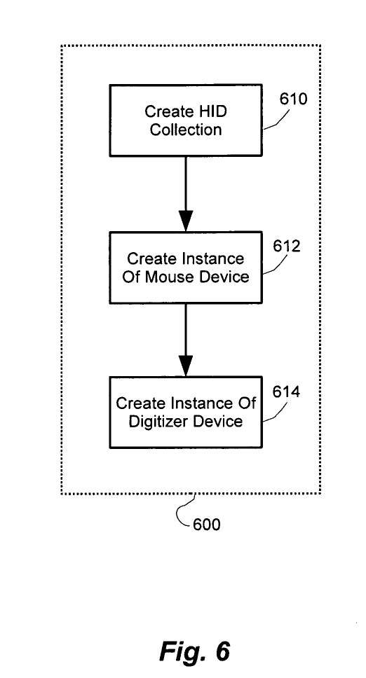

Specific operations employed in one particular process for initialing a dual-mode driver are illustrated in FIG. 6 and described below. Generally stated, initializing the dual-mode driver is accomplished by instantiating in the memory of the host computing system a common driver that includes alternative support for both the mouse and digitizer modes of operation.

At block 503, a current operating mode is set based on information about which mode the digitizer should be operating in. In certain implementations, the operating mode information may take the form of a signal from a hardware switch indicating which of the dual modes the digitizer should be operating in. In other implementations, the operating mode information may take the form of configuration information stored in a configuration file, such as a system registry. In still other implementations, the operating mode information may take the form of parameters set programmatically by other executing software. Yet other implementations may incorporate any combination of these examples, or still other mechanisms for setting the operating mode.

At block 505, the process idles until further action is taken or an event occurs. It should be appreciated that the idle state does not necessarily mean that no operations are being performed, merely that no operations pertinent to this particular exemplary process 500 are being performed.

If a digitizer event occurs, the process 500 handles the event at block 507. If an operating mode event occurs, the process 500 handles the event at block 511. For the purpose of this discussion, a digitizer event may occur based on any activity that is reported to the dual-mode driver by the digitizer, such as a pen movement, touch to the digitizer surface, or any other activity. An operating mode event may occur based on any instruction to switch operating modes, such as toggling a hardware switch from one position to another or another program programmatically instructing the dual-mode driver to switch modes.

At block 507, the dual-mode driver detects activity by the digitizer. The activity may take any one or more of many forms, such as a pen movement or click with a stylus. The detection may take the form of a message or instruction transmitted by the digitizer hardware to the dual-mode driver, perhaps using a hardware interface layer.

At block 509, the dual-mode driver reports the digitizer activity to the host computing system in accordance with the current operating mode. For example, if the current operating mode is a mouse mode, then the dual-mode driver reports the digitizer activity as a mouse. In contrast, if the current operating mode is a digitizer mode, then the dual-mode driver reports the digitizer activity as a digitizer. The process then returns to the idle state 505.

At block 511, a change in the operating state is detected by the dual-mode driver. The change in state could be triggered in any one or more of several ways. For instance, an executing software application, service, or utility could programmatically interface with the dual-mode driver to cause the operating mode to switch. Alternatively, the dual-mode driver could be notified of a change in state of a hardware switch associated with the operating mode.

At block 513, the current operating mode is modified to reflect the change detected at block 511. In certain implementations, switching the current operating mode may involve modifying configuration information to specify that digitizer activity should be reported using a mouse device rather than a digitizer device, or vice versa. The configuration information could be implemented as data structures or pointers in memory, or as data in a configuration file, such as a system registry, or both. The process then returns to the idle state 505.

FIG. 6 is an operational flow diagram generally illustrating a process 600 for initializing a dual-mode driver, in accordance with one embodiment. The process 600 may be implemented as a part of a larger process for supporting dual-mode operation of a digitizer, such as the process 500 illustrated in FIG. 5. More specifically, the block 501 of the process 500 illustrated in FIG. 5 may be implemented using the process 600 illustrated in FIG. 6. The process illustrated in FIG. 6 is but one of many different processes for initiating a dual-mode driver. Accordingly, the operations described here should be viewed merely as guidance for developing one of several alternative embodiments.

At block 610, the dual-mode driver causes to be created a HID collection that represents the dual-mode driver. As described above, the HID collection provides a common device implementation that may be understood by different operating environments that support the HID standard, including pen-aware operating systems and non pen-aware operating systems. In this particular implementation, the HID collection is configured with at least two child devices, one for each mode of operation, and the HID collection provides the operating environment with uniform access to each child device.

At block 612, an instance of a mouse device is created. In one particular implementation, the mouse device may be a HID control that is a child of the HID collection specified at block 610 above. In other implementations, the mouse device can take other forms. The mouse device may communicate with the operating environment by issuing HID reports that specify activity on a corresponding input hardware device, such as a digitizer

At block 614, an instance of a digitizer device is created. In one particular implementation, the digitizer device may be a HID control that is another child of the HID collection specified at block 610 above. In other implementations, the digitizer device can take other forms. The digitizer device may communicate with the operating environment by issuing HID reports that specify activity on a corresponding input hardware device, such as a digitizer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium having computer-executable instructions for supporting a digitizer, comprising:
initializing a dual-mode device driver, the dual-mode device driver including a first control component associated with a digitizer mode, and a second control component associated with a mouse mode;
associating a current operating mode with either the first control component or the second control component based on information about in which operating mode the digitizer is currently configured;
detecting activity by the digitizer; and
reporting the activity using the control component associated with the current operating mode.

2. The computer-readable medium recited in claim 1, wherein the dual-mode device driver is configured to issue messages compatible with a Human Input Device (HID) standard.

3. The computer-readable medium recited in claim 1, wherein the dual-mode device driver comprises a HID collection, and wherein the first and second control components are children of the HID collection.

4. The computer-readable medium recited in claim 1, wherein the first control component is operative to process a significantly greater degree of input device information pertaining to position accuracy than the second control component.

5. The computer-readable medium recited in claim 1, wherein the dual-mode device driver comprises a first report descriptor that describes the first control component, and a second report descriptor that describes the second control component.

6. The computer-readable medium recited in claim 1, wherein the instructions further comprise:
detecting a change in the operating mode; and
modifying the current operating mode to reflect the change in the operating mode.

7. The computer-readable medium recited in claim 6, wherein detecting the change in the operating mode comprises receiving an instruction to switch operating modes over a public interface exposed by the dual-mode driver.

8. The computer-readable medium recited in claim 6, wherein detecting the change in the operating mode comprises sensing a signal triggered by a hardware switch associated with the digitizer.

9. The computer-readable medium recited in claim 1, wherein initializing the dual-mode driver further comprises:
creating a HID collection;
creating an instance of a mouse device as a first child of the HID collection; and
creating an instance of a digitizer device as a second child of the HID collection.

10. The computer-readable medium recited in claim 1, wherein initializing the dual-mode driver comprises reading a registry entry to identify a default operating mode for the dual-mode driver.

11. The computer-readable medium recited in claim 1, wherein the dual-mode driver performs alignment calibration adjustment between the first and second control components.

12. A computer-implemented method for inputting data to a host computing system, comprising:
detecting activity on a human input device, the activity comprising a movement of a stylus, the activity including position information comprising coordinates for the movement and additional information;
determining a current operating mode, the current operating mode being chosen from a group comprising at least a mouse mode and a digitizer mode; and
reporting the activity using a first human input device control associated with the current operating mode, the first human input device control being a child of a collection having at least two children, at least another child being a second human input device control, the collection being associated with a common driver for the human input device.

13. The computer-implemented method recited in claim 12, wherein the human input device comprises a digitizer.

14. The computer-implemented method recited in claim 12, wherein the common driver is compatible with a Human Input Device (HID) standard.

15. The computer-implemented method recited in claim 12, wherein the first human input device control is operative to process a significantly greater degree of input device information pertaining to position accuracy than the second human input device control.

16. The computer-implemented method recited in claim 1 2, wherein the first human input device control is associated with the digitizer mode, and the second human input device control is associated with the mouse mode.

17. The computer-implemented method recited in claim 12, wherein the common driver comprises a first report descriptor that describes the first human input device control, and a second report descriptor that describes the second human input control.

18. The computer-implemented method recited in claim 12, wherein the common driver performs alignment calibration adjustment between the first and second human input device controls.

19. A computer-readable medium having computer-executable components, comprising:
a dual-mode driver configured to issue reports to a host computing system, the reports being related to activity on a human input device coupled to the host computing system, the dual-mode driver including at least two report descriptors, each report descriptor being associated with a human input device control, a first human input device control being operative to report activity by the human input device as mouse activity, a second human input device control being operative to report activity by the human input device as digitizer activity, the dual-mode driver being further configured to detect and set a current operating mode, the current operating mode being associated with a selected one of either the first or second human input device control.

20. The computer-readable medium recited in claim 19, wherein:
the dual-mode driver is compatible with a Human Input Device (HID) standard; and further wherein the dual-mode driver is configured to perform alignment calibration adjustment between the first and second human input device controls.
